(19) United States
(12) Patent Application Publication
(10) Pub. No.: US 2022/0027856 A1
(43) Pub. Date: Jan. 27, 2022

(54) INCIDENT RESPONSE TOOL

(71) Applicant: Johnson Controls Tyco IP Holdings LLP, Milwaukee, WI (US)

(72) Inventors: Ryan A. Piaskowski, Milwaukee, WI (US); Youngchoon Park, Brookfield, WI (US); Christopher Heidger, Milwaukee, WI (US)

(73) Assignee: Johnson Controls Tyco IP Holdings LLP, Milwaukee, WI (US)

(21) Appl. No.: 17/384,481

(22) Filed: Jul. 23, 2021

Related U.S. Application Data
(60) Provisional application No. 63/056,358, filed on Jul. 24, 2020.

(51) Int. Cl. G06Q 10/10; G06Q 10/06; G05B 17/02

(52) U.S. Cl. CPC G06Q 10/103; G06Q 10/1095; G06Q 50/163; G06Q 10/0637; G05B 17/02; G06Q 10/105

(57) ABSTRACT

A system for responding to events in a facility includes one or more memory devices having instructions stored thereon that, when executed by one or more processors, cause the one or more processors to perform operations including aggregating event data from a plurality of devices of a building management system (BMS) to generate an event list, receiving, via a user interface, a first indication of a first event from the event list, and in response to receiving a second indication to generate an incident based on the first event, generating the incident by determining an event type of the first event, determining a set of users previously identified to respond to the event type, and automatically generating and transmitting a meeting invite to the set of users, the meeting invite including an indication of the event type.

### CROSS-REFERENCE TO RELATED PATENT APPLICATIONS

This application claims the benefit of and priority to U.S. Provisional Patent Application No. 63/056,358, filed Jul. 24, 2020, which is incorporated herein by reference in its entirety.

### BACKGROUND

The present disclosure relates generally to an incident response tool for a building management system (BMS). More specifically, according to some illustrative embodiments, the present disclosure relates to an incident response tool that aggregates event data from multiple subsystems and automatically initiates response procedures in response to an incident.

In a BMS, separate building subsystems often include a controller or other central computing device that collects event data relating to alarms, warnings, or other conditions that may affect the operation of subsystem equipment. In some systems, a user, such as a building or facilities manager, may need to view event data for each of these subsystems separately. A BMS controller or other device may allow the user to view aggregate event data from multiple subsystems, however, response procedures for detected events are often completely manual. In other words, a building or facilities manager may spend a significant amount of time manually responding to an event and/or compiling or contacting a team to respond to the event. Accordingly, it would be desirable to aggregate event data for the equipment and spaces of a building or other facility and automatically or semi-automatically respond to detected events.

### SUMMARY

One implementation of the present disclosure is a system for responding to events in a facility. The system includes one or more memory devices having instructions stored thereon that, when executed by one or more processors, cause the one or more processors to perform operations including aggregating event data from a plurality of devices of a building management system (BMS) to generate an event list, receiving, via a user interface, a first indication of a first event from the event list, and in response to receiving a second indication to generate an incident based on the first event, generating the incident by determining an event type of the first event, determining a set of users previously identified to respond to the event type, and automatically generating and transmitting a meeting invite to the set of users, the meeting invite including an indication of the event type.

In some embodiments, the operations further include generating a multi-tile user interface by determining a first application to be displayed within a first tile using the event type, determining a second application to be displayed within a second tile using the event type, and generating the multi-tile user interface including the first tile and the second tile.

In some embodiments, the second application to be displayed within the second tile is further determined using a role of a user.

In some embodiments, the operations further include generating a graphical user interface including the event list and a 3-dimensional (3D) model of the facility.

In some embodiments, the second indication is a user input identifying the first event from the event list on the graphical user interface.

In some embodiments, the operations further include identifying a predefined standard operating procedure based on the event type, the standard operating procedure including one or more corrective actions to be executed to resolve the incident and automatically executing the one or more corrective actions.

In some embodiments, the operations further include presenting the standard operating procedure via a graphical user interface.

In some embodiments, the meeting invite includes a selectable link to at least one of a video or messaging collaboration platform.

In some embodiments, the operations further include receiving, via a graphical user interface, a user input selecting the first event from the event list and presenting, via the graphical user interface, a 3-dimensional (3D) model of a space or equipment associated with the first event.

Another implementation of the present disclosure is a method including aggregating event data from a plurality of devices of a building management system (BMS) to generate an event list, receiving, via a user interface, a first indication of a first event from the event list, and in response to receiving a second indication to generate an incident based on the first event, generating the incident by determining an event type of the first event, determining a set of users previously identified to respond to the event type, and automatically generating and transmitting a meeting invite to the set of users, the meeting invite including an indication of the event type.

In some embodiments, the method further includes generating a multi-tile user interface by determining a first application to be displayed within a first tile using the event type, determining a second application to be displayed within a second tile using the event type, and generating the multi-tile user interface including the first tile and the second tile.

In some embodiments, the second application to be displayed within the second tile is further determined using a role of a user.

In some embodiments, the method further includes generating a graphical user interface including the event list and a 3-dimensional (3D) model of the facility.

In some embodiments, the second indication is a user input identifying the first event from the event list on the graphical user interface.

In some embodiments, the method further includes identifying a predefined standard operating procedure based on the event type, the standard operating procedure including one or more corrective actions to be executed to resolve the incident and automatically executing the one or more corrective actions.

In some embodiments, the method further includes presenting the standard operating procedure via a graphical user interface.

In some embodiments, the meeting invite includes a selectable link to at least one of a video or messaging collaboration platform.

In some embodiments, the method further includes receiving, via a graphical user interface, a user input selecting the first event from the event list and presenting, via the graphical user interface, a 3-dimensional (3D) model of a space or equipment associated with the first event.

Yet another implementation of the present disclosure is a method including aggregating event data from a plurality of devices of a building management system (BMS) to generate an event list, receiving, via a user interface, a first indication of a first event from the event list, and in response to receiving a second indication to generate an incident based on the first event, generating a multi-tile user interface by determining an event type of the first event, determining a first application to be displayed within a first tile using the event type, determining a second application to be displayed within a second tile using the event type, and generating the multi-tile user interface including the first tile and the second tile.

In some embodiments, the second application to be displayed within the second tile is further determined using a role of a user.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a HVAC system, according to some embodiments.

FIG. 2 is a block diagram of a waterside system that may be used in conjunction with the building of FIG. 1, according to some embodiments.

FIG. 3 is a block diagram of an airside system that may be used in conjunction with the building of FIG. 1, according to some embodiments.

FIG. 4 is a block diagram of a building management system (BMS) that may be used to monitor and/or control the building of FIG. 1, according to some embodiments.

FIG. 5 is a block diagram of an incident response system for the BMS of FIG. 4, according to some embodiments.

FIG. 6 is a process for generating an incident in response to event data received from equipment, according to some embodiments.

FIG. 7 is an example architecture implemented by the incident response system of FIG. 5, according to some embodiments.

FIG. 8 is an example interface for presenting a 3D model of a site, according to some embodiments.

FIGS. 9A and 9B are example interfaces for presenting event data, according to various embodiments.

FIGS. 10A-10C are example interfaces for retrieving additional event data, according to various embodiments.

FIG. 11 is an example interface for automatically implementing response procedures in response to an incident, according to some embodiments.

FIGS. 12A-12C are example interfaces for completing specific steps of the response procedures, according to various embodiments.

FIG. 13 is an example interface for creating groups for automated response procedures, according to some embodiments.

FIGS. 14A-14C are examples of a command and control interface generated based on an event, according to some embodiments.

### DETAILED DESCRIPTION

Referring generally to the FIGURES, an incident response system for use with a building management system (BMS) is shown, according to some embodiments. A BMS is, in general, a system of devices configured to control, monitor, and manage equipment in or around a building or building area. A BMS can include, for example, a HVAC system, a security system, a lighting system, a fire safety system, any other system that is capable of managing building functions or devices, or any combination thereof. The incident response system can aggregate event data from the multiple subsystems of a BMS and can automate at least a portion of a response procedure based on the detected events. In some embodiments, a command and control dashboard (i.e., interface) can be generated based on a detected event, to decrease response time and/or provide for greater context when responding to incidents. Additional features and advantages of the present disclosure are described in greater detail below

Building with Building Systems

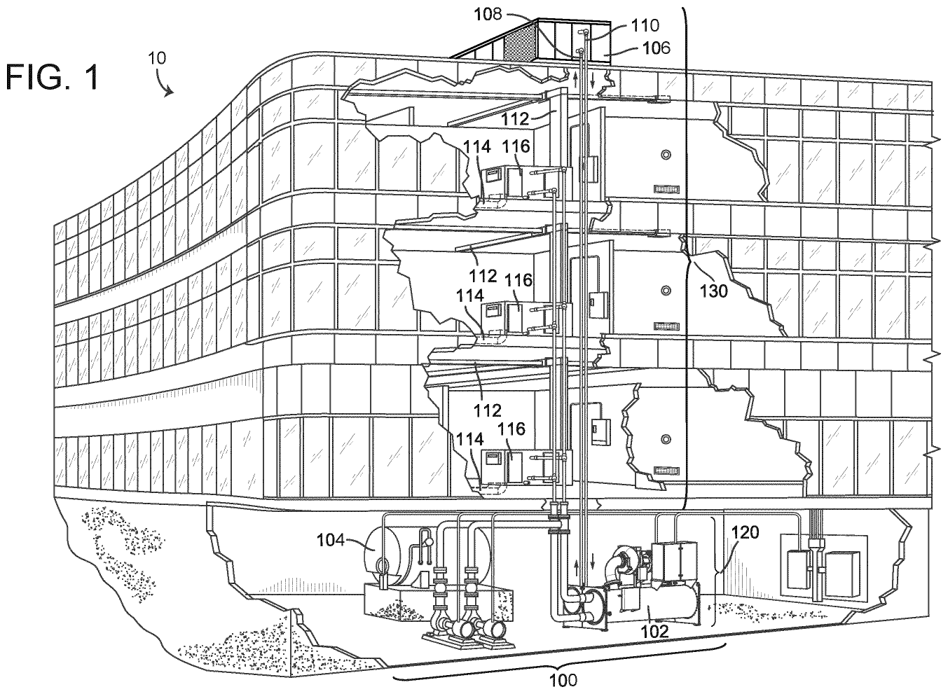

Referring now to FIGS. 1-4, an exemplary building management system (BMS) and HVAC system in which the systems and methods of the present disclosure can be implemented are shown, according to some embodiments. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire safety system, any other system that is capable of managing building functions or devices, or any combination thereof.

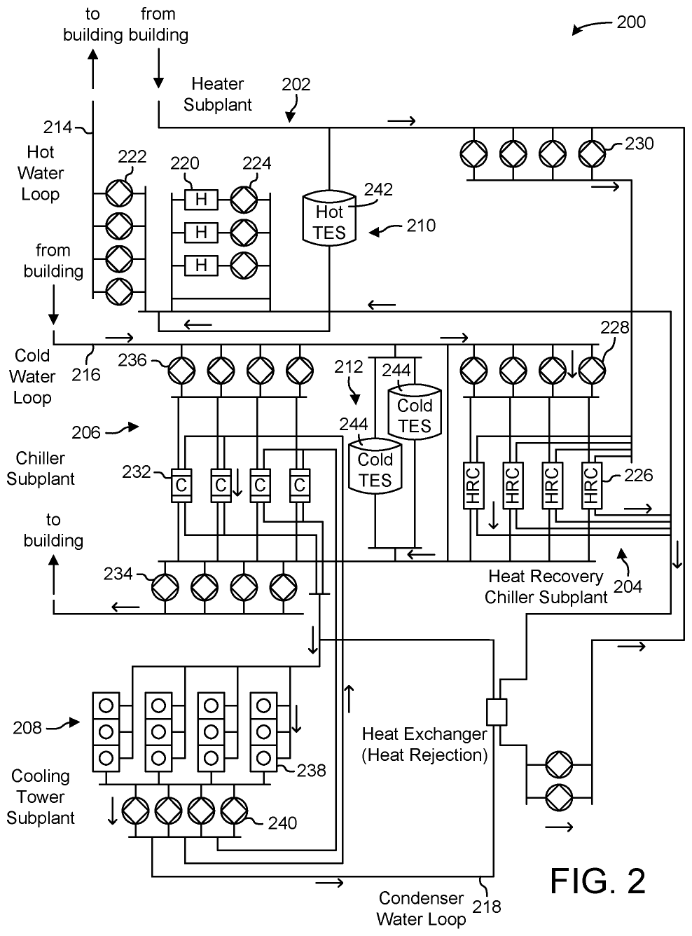

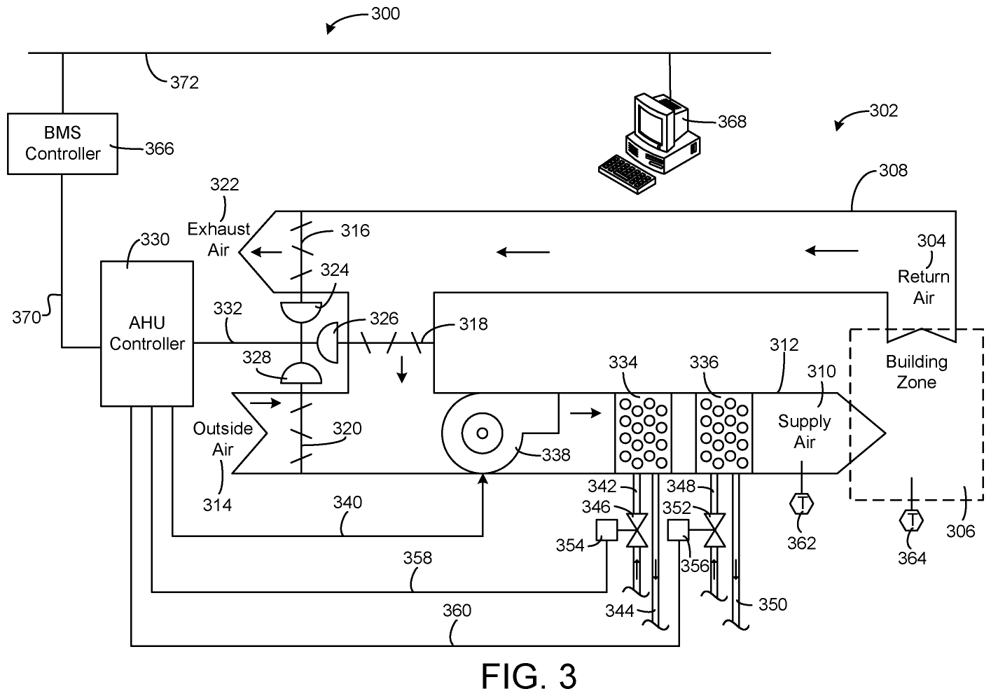

The BMS that serves building 10 includes an HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 may be configured to heat water in a hot water loop 214 that circulates the hot water between heater subplant 202 and building 10. Chiller subplant 206 may be configured to chill water in a cold water loop 216 that circulates the cold water between chiller subplant 206 building 10. Heat recovery chiller subplant 204 may be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air may be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) may be used in place of or in addition to water to serve the thermal energy loads. In other embodiments, subplants 202-212 may provide heating and/or cooling directly to the building or campus without requiring an intermediate heat transfer fluid. These and other variations to waterside system 200 are within the teachings of the present invention.

Each of subplants 202-212 may include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves may be integrated with the pumps or positioned upstream or downstream of the pumps to control the fluid flows in waterside system 200. In various embodiments, waterside system 200 may include more, fewer, or different types of devices and/or subplants based on the particular configuration of waterside system 200 and the types of loads served by waterside system 200.

Referring now to FIG. 3, a block diagram of an airside system 300 is shown, according to some embodiments. In various embodiments, airside system 300 may supplement or replace airside system 130 in HVAC system 100 or may be implemented separate from HVAC system 100. When implemented in HVAC system 100, airside system 300 may include a subset of the HVAC devices in HVAC system 100 (e.g., AHU 106, VAV units 116, ducts 112-114, fans, dampers, etc.) and may be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 may be configured to operate exhaust air damper 316, mixing damper 318, and outside air damper 320 to control an amount of outside air 314 and return air 304 that combine to form supply air 310. Any return air 304 that does not pass through mixing damper 318 may be exhausted from AHU 302 through exhaust damper 316 as exhaust air 322.

Each of dampers 316-320 may be operated by an actuator. For example, exhaust air damper 316 may be operated by actuator 324, mixing damper 318 may be operated by actuator 326, and outside air damper 320 may be operated by actuator 328. Actuators 324-328 may communicate with an AHU controller 330 via a communications link 332. Actuators 324-328 may receive control signals from AHU controller 330 and may provide feedback signals to AHU controller 330. Feedback signals may include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that may be collected, stored, or used by actuators 324-328. AHU controller 330 may be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 may be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 may be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200(e.g., from hot water loop 214) via piping 348 and may return the heated fluid to waterside system 200 via piping 350. Valve 352 may be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 may be controlled by an actuator. For example, valve 346 may be controlled by actuator 354 and valve 352 may be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 may control the temperature of supply air 310 and/or building zone 306 by activating or deactivating coils 334-336, adjusting a speed of fan 338, or a combination of both.

Still referring to FIG. 3, airside system 300 is shown to include a building automation system (BMS) controller 366 and a client device 368. BMS controller 366 may include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 may be separate (as shown in FIG. 3) or integrated. In an integrated implementation, AHU controller 330 may be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 may include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 may be a computer workstation, a client terminal, a remote or local interface, or any other type of user interface device. Client device 368 may be a stationary terminal or a mobile device. For example, client device 368 may be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

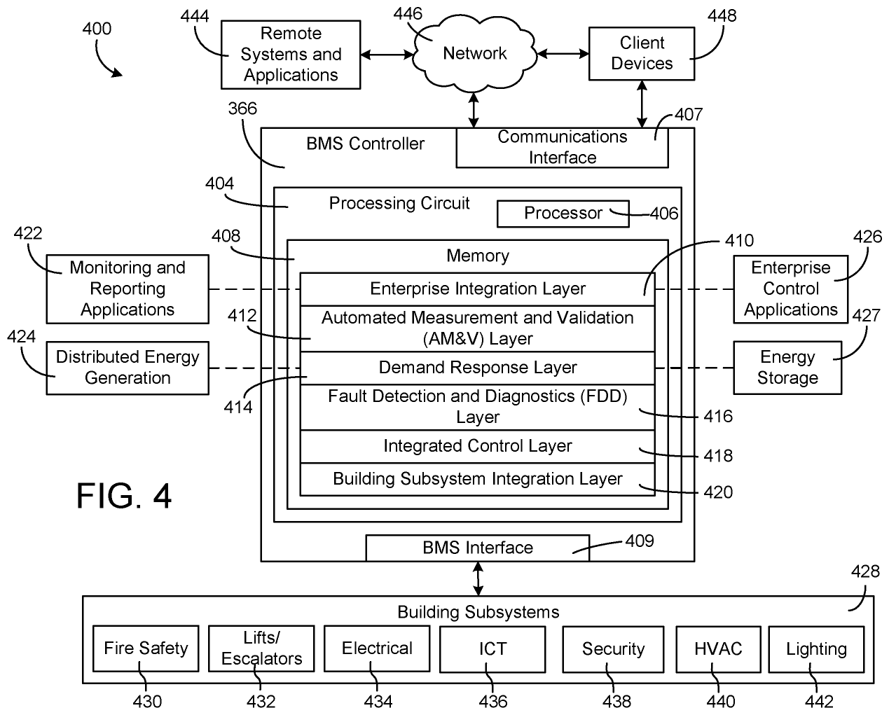

Referring now to FIG. 4, a block diagram of a building automation system (BMS) 400 is shown, according to some embodiments. BMS 400 may be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 may include any number of devices, controllers, and connections for completing its individual functions and control activities. HVAC subsystem 440 may include many of the same components as HVAC system 100, as described with reference to FIGS. 1-3. For example, HVAC subsystem 440 may include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 may include any number of light fixtures, ballasts, lighting sensors, dimmers, or other devices configured to controllably adjust the amount of light provided to a building space. Security subsystem 438 may include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 may be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a WiFi transceiver for communicating via a wireless communications network. In another example, one or both of interfaces 407, 409 may include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 may be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 408 may be or include volatile memory or non-volatile memory. Memory 408 may include database components, object code components, script components, or any other type of information structure for supporting the various activities and information structures described in the present application. According to an exemplary embodiment, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 may be distributed across multiple servers or computers (e.g., that can exist in distributed locations). Further, while FIG. 4 shows applications 422 and 426 as existing outside of BMS controller 366, in some embodiments, applications 422 and 426 may be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 may be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 may be configured to serve clients or local applications with information and services to support a variety of enterprise-level applications. For example, enterprise control applications 426 may be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 may be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 may be configured to optimize resource usage (e.g., electricity use, natural gas use, water use, etc.) and/or the monetary cost of such resource usage in response to satisfy the demand of building 10. The optimization may be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers may include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to an exemplary embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models may include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML, files, etc.). The policy definitions may be edited or adjusted by a user (e.g., via a graphical user interface) so that the control actions initiated in response to demand inputs may be tailored for the user's application, desired comfort level, particular building equipment, or based on other concerns. For example, the demand response policy definitions can specify which equipment may be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 may be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated super-system. In an exemplary embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 may be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 may be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 may be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 may be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 may be configured to provide calculated inputs (e.g., aggregations) to these higher levels based on outputs from more than one building subsystem.

Automated measurement and validation (AM&V) layer 412 may be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 may be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 may be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults may include providing an alert message to a user, a maintenance scheduling system, or a control algorithm configured to attempt to repair the fault or to work-around the fault.

FDD layer 416 may be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to an exemplary embodiment, FDD layer 416 (or a policy executed by an integrated control engine or business rules engine) may shut-down systems or direct control activities around faulty devices or systems to reduce energy waste, extend equipment life, or assure proper control response.

FDD layer 416 may be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 may include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Incident Response Tool

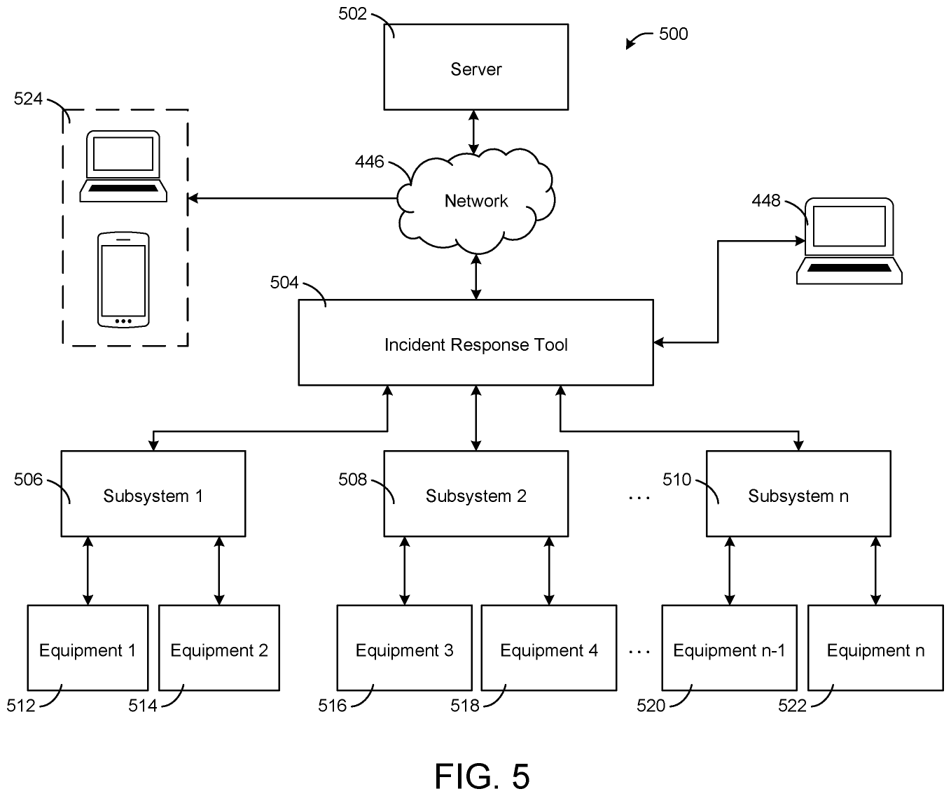

Referring now to FIG. 5, a block diagram of an incident response system 500 is shown, according to some embodiments. System 500 may provide a high-level overview of the operations of various building or site equipment, and may allow a user to quickly and efficiently respond to events that may affect the equipment. As an example, a user (e.g., a building manager) utilizing system 500 may be able to monitor events corresponding to particular building equipment and devices, and may respond to the events from a central location. In the case of a fire alarm, for example, the user could determine what device (e.g., an alarm panel, a sensor, etc.) is experiencing the fire alarm event (e.g., has detected a fire), and may initiate a response procedure to deal with the fire alarm.

System 500 is shown to include a server 502 communicably coupled to network 446. While shown as a single component (e.g., a remote server or computing device), server 502 may also be implemented across multiple servers (e.g., via a distributed computing architecture). Server 502 generally includes a processor and memory for storing and executing instructions. Similar to BMS controller 366, the memory of server 502 may include one or more devices (e.g., RAM, ROM, Flash memory, hard disk storage, etc.) for storing data and/or computer code for completing or facilitating the various processes, layers and modules described in the present application. The memory may be or include volatile memory or non-volatile memory and may include database components, object code components, script components, or any other type of information structure for supporting the various activities and information structures described in the present application.

System 500 is further shown to include an incident response tool 504. Incident response tool 504 may aggregate event data from multiple device or subsystems and may initiate automated response processes based on detected events. As described in detail below, incident response tool 504 may include and/or integrate with one or more additional platforms such as a workflow automation platform, a collaboration platform, and an active directory. Advantageously, incident response tool 504 allows for easy integration of third party services and components to increase functionality.

In some embodiments, incident response tool 504 is implemented via a dedicated computer or computing device that includes a processor and memory. For example, incident response tool 504 may be implemented via a user device such as user device 448. In other embodiments, incident response tool 504 is implemented at least partially via BMS controller 366 (e.g., within memory 408) or server 502. For example, incident response tool 504 may be implemented by a separate or dedicated computer, or may be implemented at least partially by server 502. In some embodiments, the functionality of incident response tool 504 is implemented jointly by BMS controller 366 and server 502, via network 446.

In some embodiments, incident response tool 504 is implemented in a server, multiple servers (e.g. via a distributed computing architecture), a cloud computing platform, a controller, via microservices located across multiple computing devices, and/or on (or distributed across) any other computing device or system. In some embodiments, incident response tool 504 is implemented via a processing circuit (e.g., a memory and/or a processor) and/or implemented across multiple processing circuits (e.g., multiple memories and/or processors).

As shown, incident response tool 504 may be communicably coupled to any number of subsystems 506-510. Subsystems 506-510 may include any of the building subsystems previously described with respect to FIG. 4, for example, including building electrical subsystem 434, ICT subsystem 436, security subsystem 438, HVAC subsystem 440, lighting subsystem 442, lift/escalators subsystem 432, fire safety subsystem 430, or any other subsystem associated with a building or site monitored by incident response tool 504. In some embodiments, incident response tool 504 is communicably coupled to subsystems 506-510 through BMS controller 366. Each of subsystems 506-510 is connected to a plurality of equipment, shown as equipment 512-522. For example, if subsystem 506 is an HVAC subsystem including an HVAC controller or other central controller, then each of equipment 512 and equipment 514 may include any type of HVAC device (e.g., a VAV, an AHU, etc.).

Generally, in some embodiments, each of subsystems 506-510 may include a subsystem controller or other computing device that aggregates data received from corresponding equipment 512-522. During operation of system 500 (e.g., while any of equipment 512-522 are operating or active), each of subsystems 506-510 may receive and aggregate data from any corresponding equipment regarding the operation of the equipment. For example, if subsystem 508 is a fire alarm subsystem, then equipment 516 and 518 may be fire alarm, sensors, or alarm panels that transmit data such as current values, alarms, live video/audio, etc., to a central controller. In particular, each of subsystems 506-510 may receive and aggregate alarm or event data from equipment 512-522.

As described herein, an event may be any indication received from any of equipment 512-522. As an example, an event may be an indication that a condition (i.e., a sensor value, energy usage, etc.) is outside of a normal range. An event could range from an indication of an equipment failure, for example, to a security breach within a stadium or building. In other examples, an event may indicate that a security camera is disconnected or that an area of a building is overcrowded. Those of skill in the art will appreciate that an event may include any number of conditions, and that the examples described herein are for exemplary purposed and are not intended to be limiting.

Incident response tool 504 may receive the aggregate alarm and event data from each of subsystems 506-510 and further aggregate the alarm and event data for the entire system. In this regard, incident response tool 504 may generate an overview of all alarms and events for the entire system (e.g., for all of equipment 512-522). Accordingly, a user (e.g., of user device 448) may access incident response tool 504 in order to view alarm and event data for an entire site or building from a single interface.

In addition to aggregating alarm and event data for each subsystem, incident response tool 504 may enrich the received data by retrieving additional information, such as from server 502 and/or another database. The additional information may include, for example, an indication of where equipment associated an the alarm or event is located within a building or site, what other equipment or devices are associated with or affected by the equipment experiencing the event, etc. In some embodiments, incident response tool 504 may even retrieve building information model (BIM) files or other 2D or 3D model data corresponding to the affected equipment. Accordingly, a user of user device 448 may view the additional data for an alarm or an event to determine where the event is occurring and what equipment it is affecting, and may even view 3D models of the affected equipment, as described in detail below.

In response to a detected event, such as a fire alarm or an indication that a device is not functioning properly, incident response tool 504 may automatically or semi-automatically initiate response procedures. For example, a user that is monitoring system 500 (e.g., via user device 448) may be alerted to a fire alarm affecting a particular space or equipment, and may analyze the fire alarm to gather additional information and/or validate the alarm. In this example, the user may view a model of the equipment that reported the fire alarm event (e.g., an alarm control panel) and may determine additional information such as where the equipment is located within a building. The user may validate the fire alarm, such as by viewing security camera data from a space (e.g., a hallway) near the location of the equipment or by corresponding with another user (e.g., a technician that travels to the location of the event).

Once the event is verified, the user may create an incident to initiate a response to the event. In one example, the user may select a “Create Incident” icon or button within a user interface to create the incident. In response to the user selection, an API call may be generated to create the incident. For example, selecting a “Create Incident” icon or button may cause an API call to a workflow and decision automation platform. In this example, the workflow and decision automation platform may handle at least a portion of the automated response process. In various embodiments, the workflow and decision automation platform may be included in incident response tool 504 or may called by incident response tool 504 to handle at least a portion of the creation of an incident.

Subsequently, incident response tool 504 may generate an incident and initiate automated or semi-automated response procedures. The response procedures may follow a standard operating procedure designed by a building or site manager, or by another user or group. For example, the response procedures may follow a predetermined process based on the event type and severity. In order to initiate the response procedures, incident response tool 504 may first retrieve a process corresponding to the event from server 502 and/or another database. The retrieved data may include a list of task to be performed, a list of users designated to complete the tasks, contact information for the users, and other applicable information.

As part of generating the incident, incident response tool 504 may additionally generate a meeting invitation through a communication and collaboration platform, such as a platform via which multiple users are able to meet via audio and/or video devices, share documents or other media, communicate with one another via text and/or voice, etc. Those of skill in the art will appreciate that any platform may be used that allows incident response tool 504 to generate a meeting and/or a chat room in response to an event.

To generate the meeting, incident response tool 504 may automatically create a meeting or a calendar invite, and populate the meeting or invite with information corresponding to the event. For example, the meeting may include an indication of the type of event, a location associated with the event (e.g., a location of the equipment), an indication of the particular asset or equipment that reported the event, and any other applicable information. Incident response tool 504 may transmit or send the meeting/calendar invite to a set of users associated with the particular event type. In some embodiments, incident response tool 504 may call an API associated with the communication and collaboration platform to generate the meeting.

In some embodiments, the set of users may be predetermined, such as by a building manager, and may include contact information for one or more users (e.g., technicians, security guards, etc.) that have been designated as a member of a team or group for responding to a particular event. In some embodiments, the set of users may be grouped as a team based on an active directory maintained by the building management or company. For example, a team for responding to fire alarms may be created based on a customer active directory. The generated teams may include user segmented by type (e.g., security, facility, etc.) or by space (e.g., stadium, building, etc.). In some embodiments, a new team or channel may be created corresponding to each event. In some embodiments, if the team or channel to be created corresponds to the same team as a previously created team/channel, the incident information may be added to the previous team/channel, such that the team members can view the new incident information in relation to information about prior incidents, which may be helpful in addressing the present incident.

As an example for an event associated with an HVAC subsystem, such as a chiller that indicates an alarm because it is not functioning properly, incident response tool 504 may generate a meeting request that indicates at least the type of event (e.g., “Chiller Malfunction”), a location of the effected chiller, and other information about the chiller or the event, and may transmit the meeting request to a set of users associated with the HVAC subsystem. For example, the meeting invite may be sent to one or more maintenance technicians and a building manager, so that the building manager may coordinate with the technicians to fix the chiller. As described above, the set of user that receive the meeting invite may be automatically determined based on the event type or affected equipment.

In some embodiments, the meeting request may include a link to a video, audio, and/or chat interface. For example, a link may be included within the meeting invite or post that a user may select to join a virtual meeting. Accordingly, the set of users that receive the meeting invite may join the virtual meeting and share video, audio, or text data to resolve the event. In some embodiments, the users may share video of the equipment or space associated with the event in order to troubleshoot or resolve the event. Additionally, the meeting may be automatically or manually recorded. In some embodiments, the meeting may be generated in real-time or near real-time, such that the relevant users are invited to join the meeting upon receiving the invitation. In some embodiments, the meeting may be generated for a future timeframe. In some such embodiments, the future timeframe may be determined based on factors such as, but not limited to, the availability of the users (e.g., according to shared schedules/calendars of the users), the type of the incident, the urgency of the incident, etc.

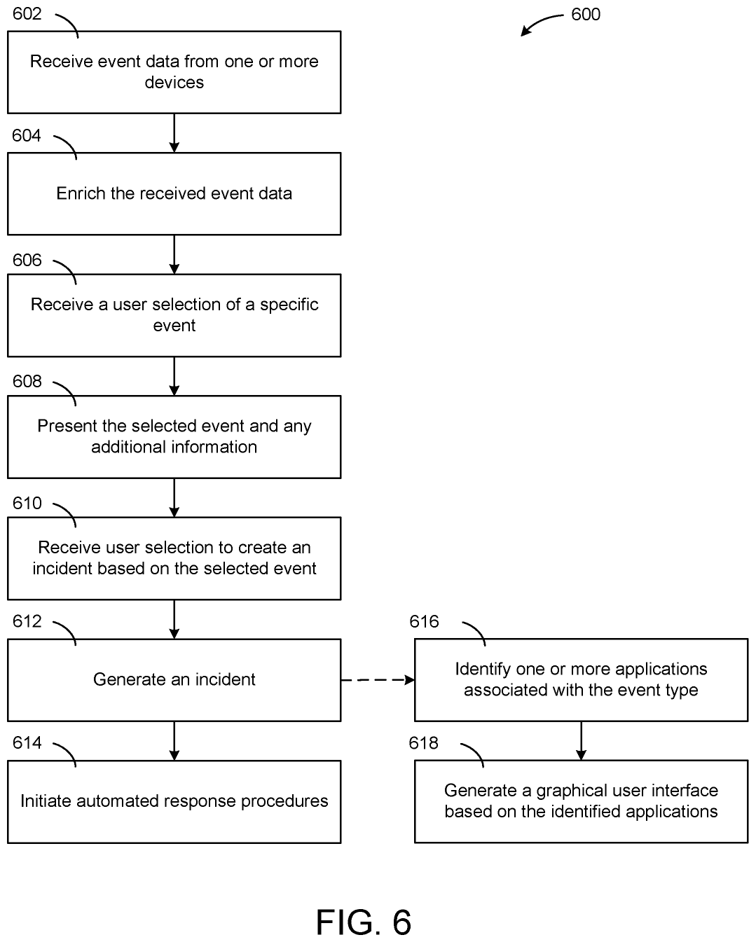

Referring now to FIG. 6, a process 600 for generating an incident in response to event data received from equipment is shown, according to some embodiments. Process 600 may be implemented by system 500, for example, and at least in part by incident response tool 504. In generally, process 600 may advantageously decrease response times for detected events by automating, at least in part, response process. Additionally, process 600 may require significantly less user interaction than other event response methods. It will be appreciated that certain steps of process 600 may be optional and, in some embodiments, process 600 may be implemented using less than all of the steps.

At step 602, event data is received from one or more devices. As described herein, the one or more devices may include any of the equipment or devices described above with respect to FIGS. 1-5. For example, the one or more devices may include any building equipment such as HVAC equipment, fire safety equipment, security equipment, etc. During operations, these devices may continuously send data to a subsystem controller that aggregates the operational data. In some cases, either the equipment or the subsystem controller may detect event conditions based on the operational data. For example, a change in the value of a smoke detector may indicate a fire, or a change in outlet water temperature for a chiller may indicate a problem with the chiller.

An incident response system or tool, as described above with respect to FIG. 5, may receive and aggregate at least the event data from any number of connected subsystems. For example, incident response tool 504 may receive data from a HVAC system, a fire alarm system, etc., and compile or aggregate the event data into an event log for the entire system. Accordingly, a user may be able to view event data for an entire system or building from a single interface, as discussed below.

As described above, an event may correspond to any of a wide variety of conditions within a system, building, site, etc. As contemplated above, for example, an event may be an indication of a fire alarm (e.g., from fire or smoke sensors), an indication of overcrowding (e.g., based on camera data), an active shoot scenario, malfunctioning equipment (e.g., based on sensor data), or any other type of event that may occur within a building, site, or BMS. In some embodiments, an event may be a violation of particular rules, such as rules intended to prevent against spread of a communicable disease (e.g., virus). For example, the event may include occupancy sensors or other occupancy detection methods indicating that the occupancy of a particular space (e.g., room, section of a stadium, etc.) has exceeded a safe occupancy level under which a social distancing level (e.g., six feet between occupants) can be maintained.

At step 604, the received and aggregated event data is enriched to provide additional information. In some embodiments, however, step 604 may not be included in process 600 (i.e., the event data is not enriched). In some cases, incident response tool 504 may retrieve additional data regarding the event, and any equipment or spaces associated with the event, from a server or other database. The additional information may include, for example, details regarding the particular device or equipment experiencing the event, a location within the building or facility of the particular device or equipment, an indication of additional equipment or devices that may be affected by the event (e.g., upstream or downstream devices from the affected device), a severity of the event, etc. In one example, if a fire alarm event is detected for a particular fire alarm panel or sensor, incident response tool 504 may retrieve a location of the fire alarm panel, an indication of any other sensors or alarms connected to the panel, etc.

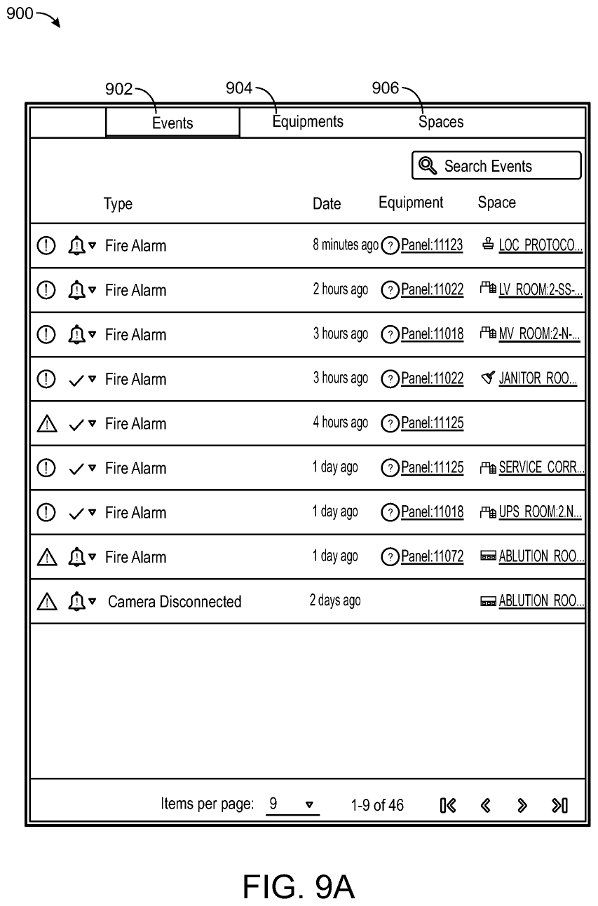

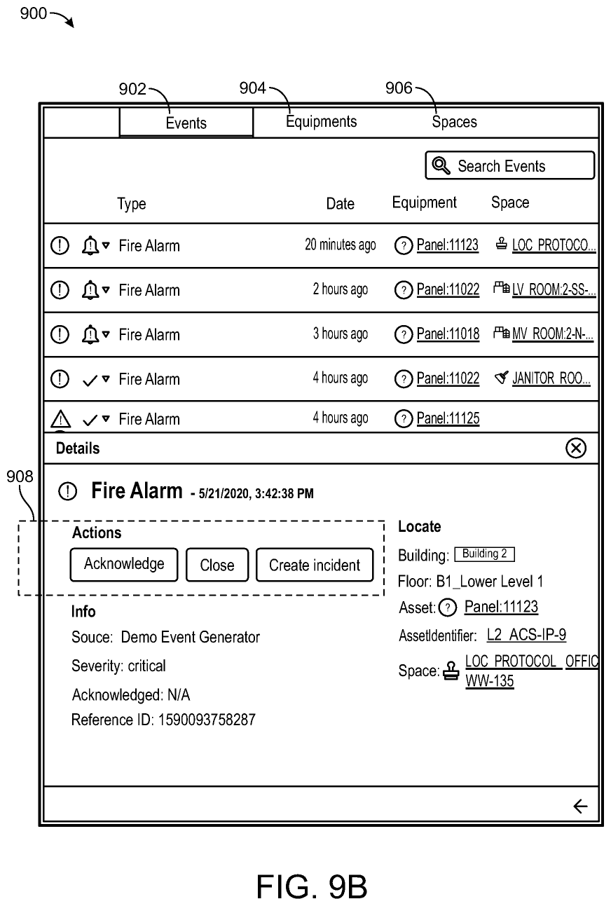

At step 606, a user selects a particular event from an aggregate list of event in order to view additional information regarding the event and/or to respond to the event. As shown in FIGS. 9A and 9B, for example, the user may select a current or historical event (e.g., a fire alarm) that the user wishes to either learn more about, or take action on. In some embodiments, the user may select the most severe event, or may select an event based on an amount of time since the event was recorded. For example, the user may select the most recent event. In some embodiments, the particular event is automatically selected (e.g., by incident response tool 504) based on any number of factors. For example, the most recently report event may be selected first.

At step 608, any additional information gathered at step 604 is presented for the selected event. As described above, for example, the user may be presented with an indication of the particular device that is affect, an indication of any other devices or equipment that may be affected if the event is not resolved, a location of the device or equipment, a severity of the event, an indication of when and/or if the event was acknowledged, etc. In some embodiments, the user is also presented with visual aids related to the event. For example, the user may be presented with a map or model of the building or the affected device.

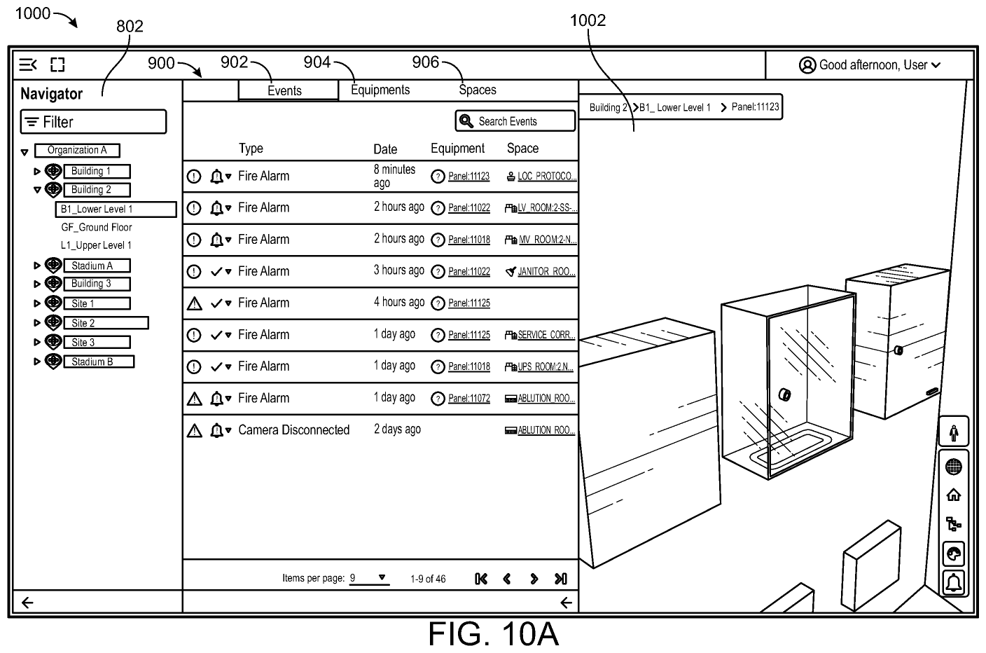

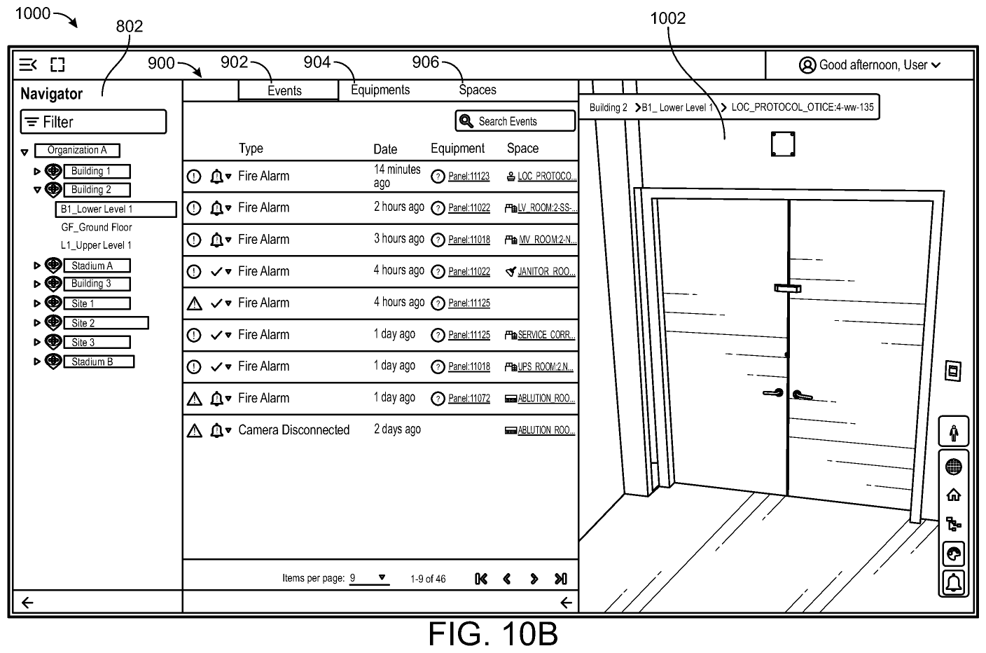

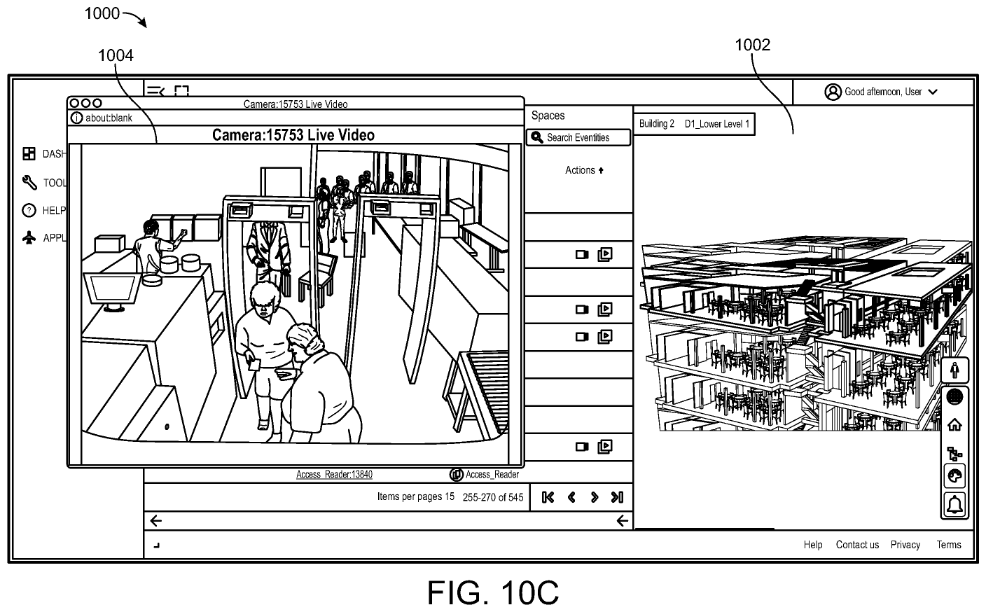

As described in detail below with respect to FIGS. 10A-10C, for example, the user may select a particular event to view a 2-dimensional or 3-dimensional (2D or 3D) model of the equipment or space associated with the event, or of a space associated with the equipment. Using the 3D model, a user may gather additional information, such as identifying other nearby equipment, locating equipment within the building, determining ingress or egress routes, etc. Additionally, the 3D model may provide a visual indication of upstream or downstream devices that may be affected by the event. For example, if a chiller is malfunctioning, a user may use the 3D model to determine that a VAV or AHU may be affected. In another example, an event such as overcrowding or an altercation in a stadium may be recorded, and the user may use a model of the space associated with the event to respond.

In addition to or instead of a 3D model of the equipment or space associated with the event, the user may also view video and/or audio feeds from cameras and other devices near the event. For example, the user may utilize the 3D model to locate a nearby security camera, and may access a video feed from the camera to view the equipment. In the event of a fire, for example, the user could access a camera near the alarm or panel that created the event in order to determine whether the fire alarm was a false positive.

At step 610, the user may indicate that an incident should be created for the selected event. In some embodiments, the user may select an icon or button that is presented with the additional information at step 608 in order to create the incident. In other embodiments, step 610 may be completed by incident response tool 504 by automatically generating an incident based on a detected event. The incident may, in essence, elevate the event in order to initiate a response. In some embodiments, the user may indicate that the incident should be generated only after validating the event (e.g., using cameras, manually, etc.). Referring again to the fire alarm example, the user may choose not to create an incident until the user visually confirms that the alarm is not a false positive.

At step 612, the incident is generated. More specifically, the generation of the incident initiates a workflow process to respond to the event. In some embodiments, in response to an indication that the incident should be created for a given event, a message (e.g., an API call) is sent to a dedicated workflow engine (e.g., part of incident response tool 504 and/or server 502) to start an incident response process.

In some embodiments, process 600 continues to step 614 after the generation of an incident. However, in other embodiments, process 600 continues to step 616 before, or in parallel with, or before step 614. For example, after an incident is generated, incident response tool 504 may continue to steps 614 and 616 simultaneously, or nearly simultaneously. Accordingly, step 616 is shown as an optional step after step 612, indicated by the broken (i.e., dashed arrow). Step 616 is described in greater detail below.

At step 614, in response to generating the incident, a number of automated or semi-automated response procedures are initiated. As described above, any number of the response procedures may be initiated by calling an appropriate API, in some cases. In some embodiments, a meeting or calendar event for the incident is automatically created and shared within a channel or group of a collaboration tool, or may be sent to an email or personal device of a number of predetermined users. The predetermined users and/or group associated with the meeting may be selected based on at least the type of event, as discussed below.

As described above, a set of users (e.g., technicians, building or event managers, public service workers, first responders, etc.) may be determined during configuration of system 500 and/or incident response tool 504 based on an active directory maintained by a building manager or company. Based on the active directory, user may be segmented into groups or teams (e.g., within the communication and collaboration platform) based on any number of factors. For example, users involved in building security may be segmented into a fire emergency group while maintenance technicians may be segmented into a HVAC response group. It will be appreciate that these teams or groups may be compiled based on any other factors, such as location, job title, etc. The active directory may be accessed to determine contact information for the users of a particular group, in order to transmit the meeting invite or to alert members of a team or group to the meeting posting within the group channel of a collaboration tool.

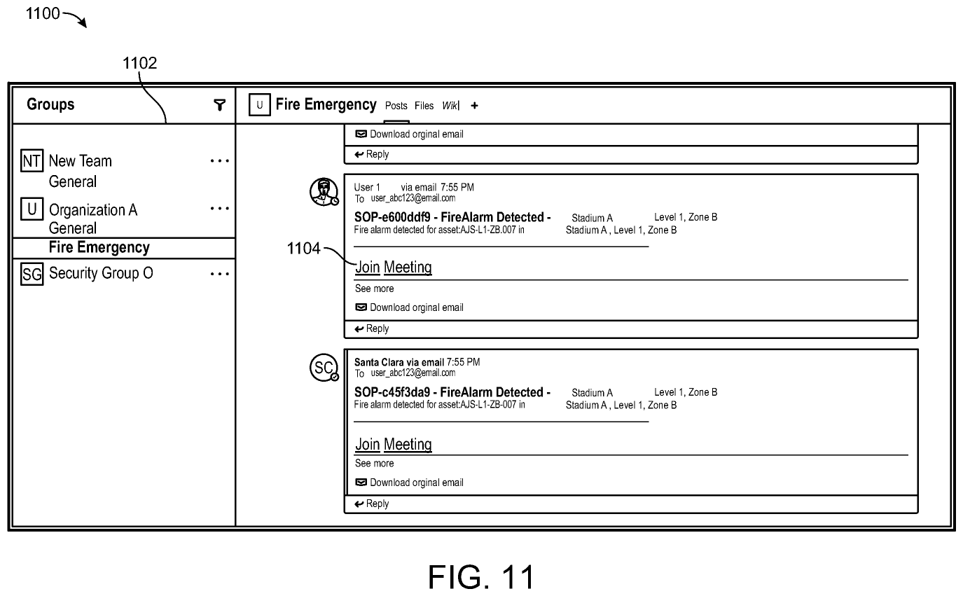

In creating the meeting invite, a team, channel, or group is selected based on the type of event. For example, if the event is a fire alarm, a fire emergency group would be prompted to join the meeting via a personal device. Accordingly, any number of users associated with the fire emergency group could quickly access the meeting to discuss the event. Additionally, the meeting may be enriched with data (e.g., retrieved at step 604) in order to provide each participant in the meeting with information regarding the event. For example, the meeting may include an indication of a space or equipment associated with the event, event details, etc. Further details about the creation of a meeting based on an event are discussed below with respect to FIG. 11.

After receiving an indication of a meeting regarding a generated incident, or by accessing the meeting from a team or group page of a collaboration platform, members of the team or group may access the meeting to share video, audio, or textual information. As described in detail with respect to FIG. 11, for example, the users may discuss the incident in order to address the event. In one example, on-ground users may share live video or audio from the location of the event, to provide additional information to a first user (e.g., a manager, a command and control center, etc.). Further, in some embodiments, a team manager or response procedure designer may designate whether or not meetings are recorded.

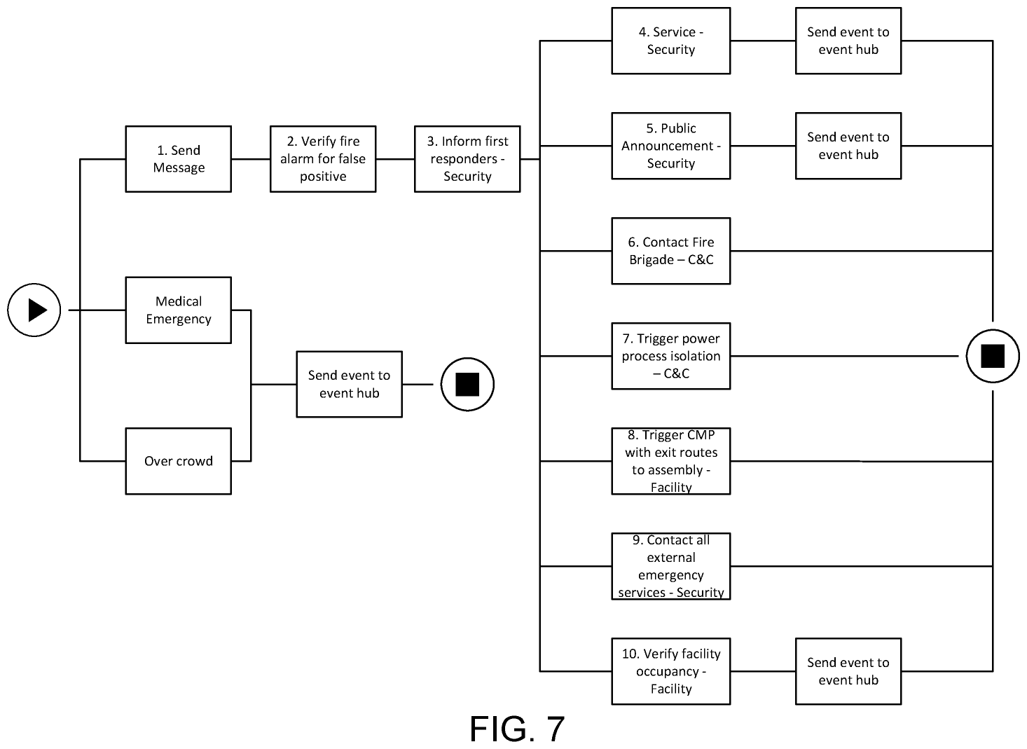

In addition or instead of automatically creating a meeting and prompting members of a corresponding team or group to join the meeting, a number of other tasks may be initiated. In some embodiments, incident response tool 504 may further call an API to a workflow and decision automation platform to initiate additional task. In some embodiments, the workflow and decision automation platform may be implemented wholly or partial by incident response tool 504 and/or server 502. The architecture of the workflow implemented by system 500 is described in detail with respect to FIG. 7.

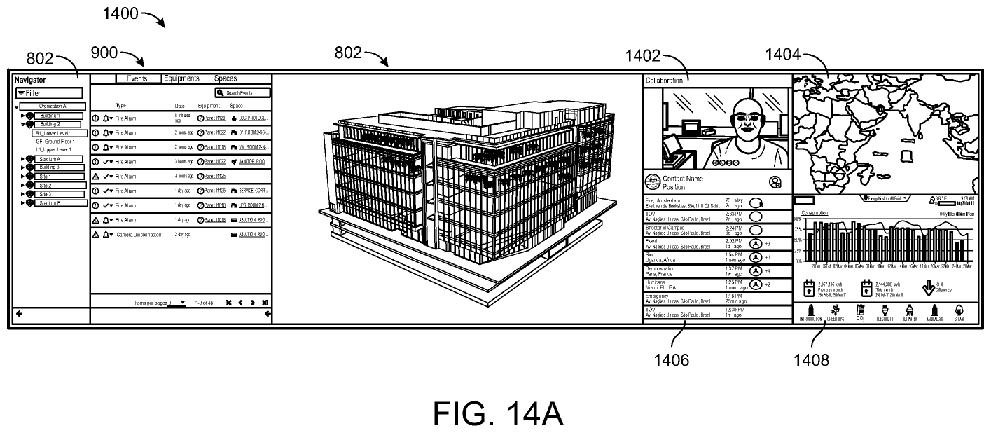

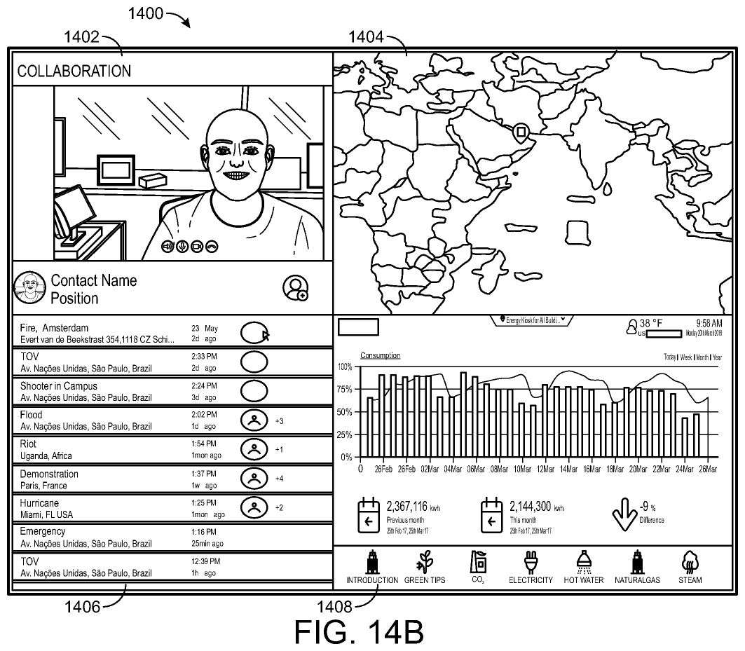

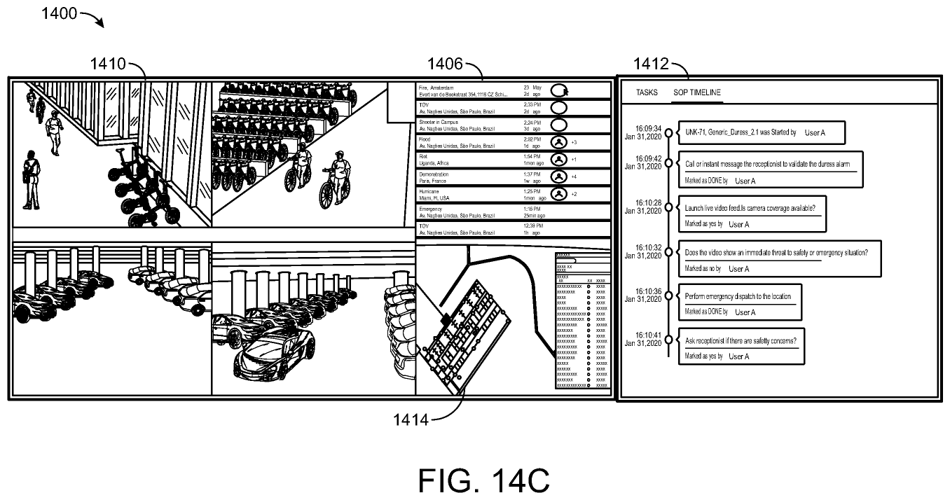

In some implementations, in addition to or instead of initiating particular actions, incident response tool 504 may provide a command and control interface to assist in addressing incidents. At step 616, one or more applications are identified to be included in a command and control interface. As described above, step 616 may optionally be implemented concurrently with step 612, or may be implemented at any time before or after step 614. The one or more applications may include any local or remote (e.g., web-based) applications that may be hosted (i.e., implemented) by either system 500 or any number of other external systems (e.g., servers, remote computing devices, etc.). As described below in greater detail, with respect to FIGS. 14A-14C, the one or more applications can include a variety of information. For example, the one or more applications may include a weather data or news application, feeds from one or more security cameras, data from a subsystem controller, asset or equipment statuses, etc.

In some embodiments, the one or more applications are identified based on a type of the selected event. For example, based on the generation of an incident based on an event corresponding to a malfunction of HVAC equipment, a variety of applications relating to the operation of the HVAC equipment may be identified. In this example, applications that illustrate current operating parameters (e.g., sensor values, temperatures, speeds, etc.) of the HVAC equipment may be selected. In another example, where the incident relates to an active shooter event, applications for viewing live security camera footage or for controlling access control devices (e.g., door locks, card readers, etc.) may be identified.

In some embodiments, the one or more applications are identified based at least in part on a role associated with a first user (e.g., the user logged-in to system 500 or accessing the command and control interface). More specifically, a user in a particular role may be associated with a particular set of the one or more applications. In some cases, both the role (e.g., security) of a user and the type of the event (e.g., unauthorized access, overcrowding) may be considered to identify the particular set of applications. As an example, a user designated as a site supervisor or admin may be granted additional permissions to view or interact with certain applications. An administrator, for example, may view a response procedure task list, as shown in FIG. 14C, in order to track the work of other team members, whereas a team member may not need to track the response procedure task list. Accordingly, a first set of applications may be identified for the first user (e.g., the admin), whereas a second, different set of applications may be selected for a team member.

In another example, a user that is designated as a maintenance or service technician may be associated with different applications that a security guard. To further this example, in the case of a malfunctioning access control device (e.g., a card reader), a first set of applications relating to equipment operating data, maintenance history, sensor data, etc., may be identified for a maintenance technician while a second set of applications relating to security camera feeds, card reader logs, etc. may be identified for the security guard. Accordingly, the maintenance technician could access applications that would aid in the resolution of the malfunction (e.g., by fixing the faulty card reader) while the security guard could check that the malfunction was not related to a security breach.

In some implementations, the one or more applications may be determined based on user preferences. For example, for an incident relating to a same event type, and for two users having the same or a similar role, the applications chosen to be included in the interface, and/or the layout of the tiles within the interface, may be different based on user preferences. The preferences may be stored within a database for each user and used upon the occurrence of an incident to generate the interface according to the user preferences.

At step 618, a graphical user interface is generated based on the identified applications. The graphical user interface may be the command and control interface discussed above with respect to step 616 or as described in detail below with respect to FIGS. 14A-14C. The user interface generated at step 618 may include a variety of dynamically configurable tiles or widgets that present data from the one or more applications. In other words, the one or more applications “feed” data to populate the interface. Advantageously, this allows system 500 to provide a large amount of data relating to site operations and/or events within the user interface without necessarily requiring system 500 to handle all the data. In other words, a plurality of external or internal computing systems (e.g., servers) can handle data collection, manipulation, and aggregation, and subsequently provide the data to system 500 for presentation via the command and control interface. In this regard, utilizing tiles as described herein leads to a more lightweight program/system and allows for the easy integration of third-party components (e.g., additional applications).

The “command and control” interface is dynamically configurable such that any number of a variety of applications may be presented within the tiles. As described above, for example, the one or more applications presented within the tiles may be selected based on an event type or based on a role of a user. Accordingly, the command and control interface dynamically updates or adjusted based on the event type and user role. For example, the interface generated for a system administrator may be different than the interface generated for a first responder. Likewise, the interface generated for a security event may be different than the interface generated for an equipment malfunction.

Additionally, the layout of the interface may be dynamically configured based on one or both of the event type of the user's role. For example, in the event of overcrowding of a stadium, the interface may be configured so that security camera footage is displayed prominently (e.g., in the center of the interface). In this regard, the command and control interface may beneficially provide a single, dynamic interface for response to a wide variety of events that helps to increase response efficiency.

In some embodiments, the applications or tiles, and/or the layout of the command and control interface may also be customized by a user. For example, the user may establish a default view comprising one or more user selected applications (e.g., weather, news, social media, equipment operating data, etc.). Subsequently, the interface may be changed or updated once the user selects a particular event. Once the event is resolved (e.g., marked “done” or “complete”), the interface may revert back to the user's default interface.

Referring now to FIG. 7, an example architecture 700 implemented by system 500 is shown, according to some embodiments. Architecture 700 generally represents a flow of data and/or steps taken by system 500 in the creation of an event. In other words, architecture 700 is an example workflow implemented by system 500. In some embodiments, portions of architecture 700 are handled by a remote computing device such as server 502 in addition to incident response tool 504. For example, one or more steps illustrated in architecture 700 may be “back-end” processes completed by server 502 in coordination with incident response tool 504. It will be appreciated that architecture 700 represents an example of a response architecture for a limited number of event types, however, any number of additional events and steps may be implemented by system 500.

As described above, system 500 may initiate a response process workflow such as architecture 700 automatically, in response to the creation of an incident based on an event. A response process designer or team manager may establish the response process for any number of events (e.g., a fire, an active shooter, etc.) during configuration. Accordingly, when an event is detected, incident response tool 504 may determine an appropriate response process based on the event type. As an example, certain events may be auto-escalating while others may not be escalated without user intervention. In the event of a fire, for example, additional steps of a response process may be automated such as calling the fire department and triggering power isolation processes, as described below. In contrast, an equipment malfunction (e.g., a VAV malfunction) may not be as critical as a fire. In this example, the event may not be escalated until selected by a user.

In response to initiating a response process (i.e., a workflow), incident response tool 504 may call an API, as described above, to initiate one or more response tasks. In some embodiments, however, at least a portion of the response process is handled by incident response tool 504. The response process may include multiple individual tasks that are either automatically completed by incident response tool 504 and/or another component of system 500, or are initiated (e.g., by sending a prompt or notification) for completion by a user. As tasks are completed by various users, or automatically, updates may be presented in the meeting (e.g., created at step 614 of process 600). Accordingly, a first user and one or more additional users that are participating in the meeting may receive updates to track the response process.

As shown, architecture 700 contemplates three detected events, including a fire alarm, a medical emergency, and an over crowd event. In the event of a detected medical emergency or overcrowding, architecture 700 shows that the event is sent to an event hub and no additional action is taken by system 500. However, in the event of a fire alarm, incident response tool 504 first sends a message through a communication and collaboration platform. The message may read, for example, “Fire alarm detected for asset <name> in <building>, <level>,<zone>.” Subsequently, a first user (e.g., a building manager or system operator) may verify the fire alarm for false positives and, assuming the fire alarm is real, may inform first responders and security. During these second and third steps, incident response tool 504 may provide prompts to the first user (e.g., via user device 448) to verify the asset, inform first responders, and trigger an evacuation of a corresponding location of the building.

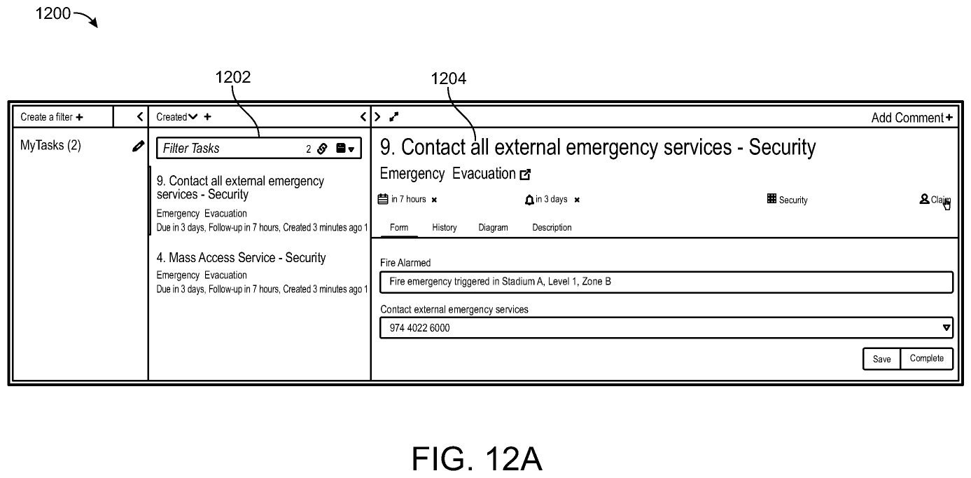

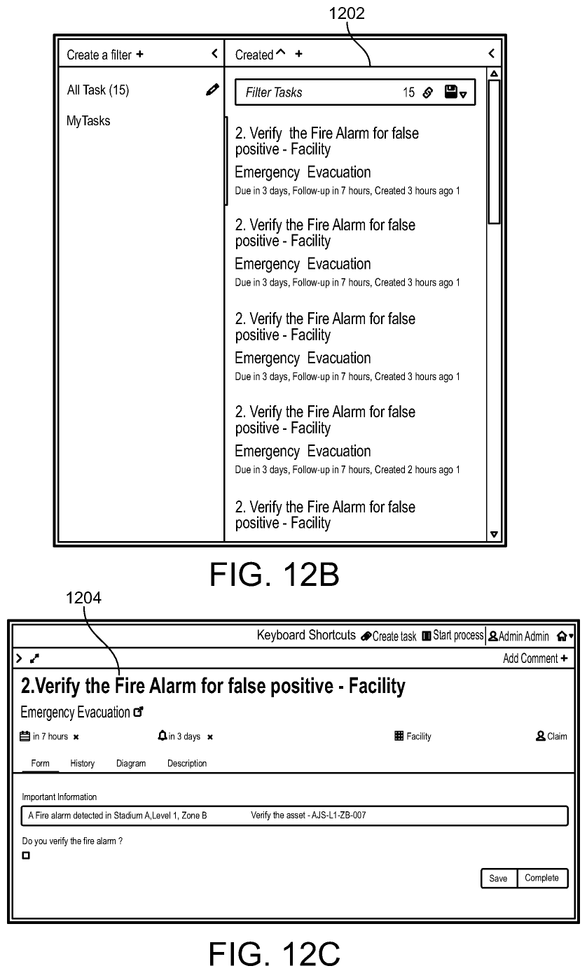

After first responders have been informed, incident response tool 504 may initiate a plurality of tasks in parallel, as shown. As described above, in some embodiments, at least a portion of the tasks are handled by various other users that are part of a fire emergency or fire alarm response team or group, as previously described. Additionally, each of the various users may receive an indication of a particular task to complete, as described below with respect to FIGS. 12A-12C. In some embodiments, the users fire emergency or fire alarm response team are assigned to a particular task before the creation of an incident (e.g., during configuration).

As shown in the example architecture of FIG. 7, the plurality of tasks performed in parallel may include indications for a user (e.g., the user receiving the notice to perform the task) to announce the fire emergency, contact a fire brigade, trigger power isolation processes, trigger all available displays to indicate an exit route, contact external emergency services (e.g., police), a verify facility occupancy to ensure that all occupants have left. Once each of the task have been completed, the corresponding user that has completed the task may indicate that the task have been completed. Accordingly, the first user may monitor the progress of the various other users in completing tasks.

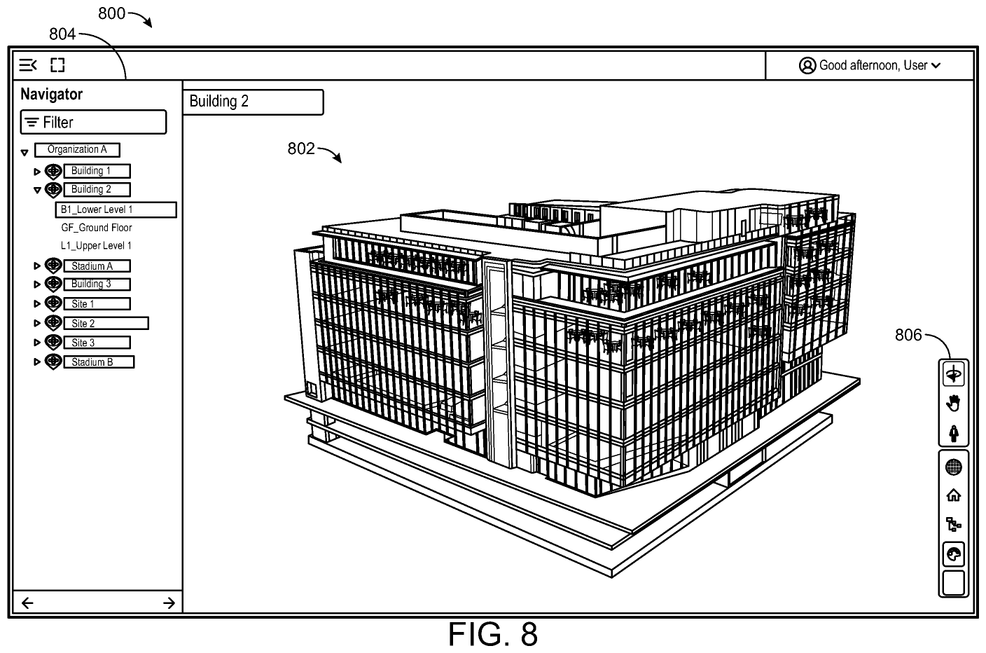

Referring now to FIG. 8, an example interface 800 for presenting a 3D model 802 of a site is shown, according to some embodiments. More specifically, model 802 is shown as a 3D representation of a building (e.g., an office building). In other embodiments, model 802 may represent any other type of facility or space, such as a sports stadium, a university, etc. 3D model 802 may be rendered from a building information model (BIM) file or by another means for generating 3D models of a space and equipment. A BIM is a representation of the physical and/or functional characteristics of a building. A BIM may represent structural characteristics of the building (e.g., walls, floors, ceilings, doors, windows, etc.) as well as the systems or components contained within the building (e.g., lighting components, electrical systems, mechanical systems, HVAC components, furniture, plumbing systems or fixtures, etc.). It will be appreciated that BIMs may be used to represent a variety of facilities including campuses, sites, building, etc., and that the term “building”, as denoted herein, is not intended to be limiting.

In some embodiments, a BIM is a 3D graphical model of the building. A BIM may be created using computer modeling software or other computer-aided design (CAD) tools and may be used by any of a plurality of entities that provide building-related services. For example, a BIM may be used by architects, contractors, landscape architects, surveyors, civil engineers, structural engineers, building services engineers, building owners/operators, or any other entity to obtain information about the building and/or the components contained therein. A BIM may replace 2D technical drawings (e.g., plans, elevations, sections, etc.) and may provide significantly more information than traditional 2D drawings. For example, a BIM may include spatial relationships, light information, geographic information, and/or qualities or properties of building components (e.g., manufacturer details).

In some embodiments, a BIM represents building components as objects (e.g., software objects). For example, a BIM may include a plurality of objects that represent physical components within the building as well as building spaces. Each object may include a collection of attributes that define the physical geometry of the object, the type of object, and/or other properties of the object. For example, objects representing building spaces may define the size and location of the building space. Objects representing physical components may define the geometry of the physical component, the type of component (e.g., lighting fixture, air handling unit, wall, etc.), the location of the physical component, a material from which the physical component is constructed, one or more functional characteristics/capabilities of the physical component, and/or other attributes of the physical component.

A BIM can be viewed and manipulated using a 3D modeling program (e.g., CAD software), a model viewer, a web browser, and/or any other software capable of interpreting and rendering the information contained within the BIM. As an example, either server 502 or BMS controller 366 may include a model viewer configured to render and display 3D models from BIM files on a user device (e.g., user device 448). Appropriate viewing software may allow a user to view the representation of the building from any of a variety of perspectives and/or locations. For example, a user can view the BIM from a perspective within the building to see how the building would look from that location. In other words, a user can simulate the perspective of a person within the building.

While various implementations shown herein illustrate providing renderings of buildings or portions thereof as BIMs, it should be understood that a BIM is merely one example implementation in which buildings or portions thereof can be represented. Various other illustrations of buildings, building spaces, equipment, people, etc. may be utilized in various embodiments, and all such illustrations are contemplated within the scope of the present disclosure.

Still referring to FIG. 8, interface 800 is shown to include a navigation menu 804. Menu 804 includes one or more dropdown menus corresponding to various 3D models or BIM files. By selecting a particular model or file, a user may view a 3D rendering of the selected model, and/or may navigate between views (e.g., by changing the model presented in interface 800). As shown in FIG. 8, for example, a user may select “B1_Lower Level 1” from menu 804 in order to change 3D model 802 to a rendering of a particular level of “Building 2.” Interface 800 is also shown to include a variety of navigation elements 806 for adjusting the view of 3D model 802 (e.g., by zooming, panning, etc.).

Referring now to FIGS. 9A and 9B, an example interface 900 for presenting event data is shown, according to some embodiments. In some embodiments, interface 900 is a stand-alone interface, or may be presented within interface 800 as previously described. Interface 900 is shown to include various navigation tabs 902-906, for navigating between various menus. In the example of FIG. 9A, an events tab 902 is selected, thereby presenting a list of events for a site or building monitored by the incident response tool and/or BMS. A user may select another one of tabs 904 or 906 to navigate to other menus for viewing notification relating to site equipment or spaces. Additionally, the user may use a search bar to filter the presented events. In this manner, interface 900 provides an easy-to-understand and comprehensive, high-level overview of equipment event conditions, allowing a user (e.g., a site manager) to quickly view and respond to events.

As shown in FIG. 9A, this example of interface 900 shows a list of various fire alarm event and a “camera disconnected” event. In addition to presenting the event type, a date or time that the event was recorded is shown, along with the effected equipment and space. Additionally, various icons (e.g., a bell icon, a checkmark, etc.) are shown that can indicate a current status and/or severity of the event. In one example, the first listed event is a fire alarm, recorded 8 minutes ago. Interface 900 shows that “Panel:11123” located in space “LOC_PROTOCO . . . ” is the particular equipment experiencing the event. In this case, “Panel:11123” may be a fire alarm control panel that controls one or more fire or smoke sensors, fire alarms, etc. Additionally, the first listed fire alarm event is indicated with an icon that indicates that the event is severe or very important, and an icon that indicates that the alarm is still occurring (e.g., that the alarm has not yet been responded to).

From interface 900, a user can select a particular event to view additional information. The additional information, for example, can include any of the data retrieved during enrichment at step 604 of process 600. As an example, the user may select one of the equipment or space indications for a particular event in order to view more information on the selected equipment or space, as described in more detail with respect to FIGS. 10A-10C. The user may also select the alarm itself to be presented with a second interface or other graphical element (e.g., a pop-up, an overlay, etc.) that presents the additional information (e.g., as retrieved at step 604 of process 600).

As shown in FIG. 9B, for example, the user has selected a particular fire alarm event. Accordingly, a second graphical element is presented over interface 900 that provides additional details on the select fire alarm. In some embodiments, the type of event may determine the particular content displayed in the second graphical element. In this case, the particular time and date that the alarm was recorded is shown, along with the specific location. As shown in FIG. 9B, this example fire alarm is occurring in building “Building 2” on floor “B1_Lower Level 1,” and is affecting asset “Panel:11123” in space “LOC_PROTOCOL_OFFICE:4-WW-135.” Additionally, information such as the source (“Demo Event Generator”) and the severity (“Critical”) of the alarm are shown, along with the event reference ID and an indication on whether the even was acknowledge.

In some embodiments, a user may select one of the action buttons 908, in order to respond to the selected event. As shown, the user may choose to acknowledge the event, close the event, or create an incident. A user may choose to acknowledge an event rather than to create an incident for a number of reasons. For example, the event may have a very low severity or may not be critical to the operation of a building or to the safety of occupants. In this example, the user may select the acknowledge button and respond to the event offline (e.g., by sending a maintenance technician at a later time). An event may be closed, for example, after the event has been resolved. For example, after a fire corresponding to a fire alarm event is extinguished, or after confirmation of a false alarm, the user may close the corresponding event. Finally, the user may choose to create an incident corresponding to the alarm, as described in detail above.

Referring now to FIGS. 10A-10C, an example interface 1000 for retrieving additional event data is shown, according to various embodiments. Interface 1000 is shown to include interface 900 along with elements of interface 800. Interface 1000 can provide additional information relating to a selected event, such as equipment, space, and/or camera data. Accordingly, a user responding to an event can gather a variety of different information from interface 1000 that may be crucial to responding to the event.

In addition to menu 804 and interface 900, interface 1000 includes a 3D model viewer 1002. As shown, for example, 3D model viewer 1002 may present a 3D model or rendering of particular equipment or spaces within a site or building. As previously described, the 3D models may be rendered from BIM files in some cases. In the example of FIG. 10A, a user has selected a particular equipment corresponding to an alarm within interface 900. In this example, “Panel:11123,” corresponding to the first fire alarm event listed in interface 900, is selected. In response, a 3D model of “Panel:11123” is rendered in 3D model viewer 1002. Based on the 3D model of the effect equipment, the user can gather additional information such as upstream or downstream equipment that may be affected by the event.

FIG. 10B shows an example of a user selecting a space from interface 900. In particular, FIG. 10B shows that “LOC_PROTOCOL_OFFICE:4-WW-135” has been selected, corresponding to the first fire alarm event listed in interface 900. Accordingly, a 3D rendering or model of the selected location is presented. In this case, 3D model viewer 1002 shows a 3D model of an entry way and a portion of a hallway corresponding to the selected location. The 3D model may be a representation of a doorway to an office, for example. As with the 3D of the equipment shown in FIG. 10A, by viewing a model of an affected space, a user may gather additional information, such as to determine whether any critical equipment is near the location of the event. In the example of a fire alarm, viewing a 3D model of a space may help the user to plan an evacuation route.

In some embodiments, a user may access security camera feeds associated with an event. As an example, in the event of a fire alarm, the user may access security camera feeds from a hallway near the alarm (i.e., the equipment affected by the event) in order to assess the cause of the event. In this example, the user may use the camera feeds to look for smoke or fire near the affect equipment in order to determine whether the fire is real, or a false alarm. As shown in FIG. 10C, selecting a particular camera associated with the event causes a video feed from the camera to be presented in a viewer 1004. Viewer 1004 may be a pop-up window, a new graphical user interface, an overlay to interface 1000, or may be presented in another way. In any case, viewer 1004 provides a live video feed from the selected camera associated with the event, as shown.

Referring now to FIG. 11, an example interface 1100 for automatically implementing response procedures in response to an incident are shown, according to various embodiments. In particular, interface 11000 may be presented in response to a user creating an incident from an event (e.g., by selecting “Create Incident” from interface 900). The automated response procedures, in this case, include automatically creating a meeting, populating the meeting with details regarding the event, and transmitting the meeting to a selection of previously identified users, as described above with respect to process 600. In this regard, the interfaces shown may be example of interfaces generated and presented at step 614 of process 600.

Interface 1100 may be an example of a particular page for a team or group within any communication and collaboration platform. In the example shown, interface 1100 is presenting a team page for a “Fire Emergency” group within the platform. Using a navigation menu 1102, a user may navigate between pages and/or groups within the communication and collaboration platform. In the example shown, the groups or teams are separated by site and by emergency type. For example, the “Fire Emergency” team shown is associated with a particular organization or site, “Organization A.”

In response to a user creating an incident based on an event, as described above, a meeting may be automatically generated within the communication and collaboration platform. In this example, a meeting 1104 is scheduled and a post regarding meeting 1104 is automatically shared within the group. In some embodiments, an indication of the meeting is also transmitted via email, text, or voice call to a device associated with one or more users of the group. A variety of information is included within meeting 1104, including a description of the incident, a location, and indication of the user that initiated the creation of the incident. For example, “User 1” is shown to have created an incident for a fire alarm within Building 2, Level 1, Zone B. Additionally, an indication of the asset (“AJS-L1-ZB-007”) is shown. By sharing meeting 1104 within the communication and collaboration platform group, users that may not have received an email or other notification regarding the incident could join in the meeting.

In some embodiments, a user may be presented with another interface, or interface 1100 may be updated, when a user selects “Join Meeting” from a meeting presented within interface 1100, or may be presented when a user joins the meeting using a link in an email, text, or other notification sent to a mobile device of the user. In particular, a user that is designated within the “Fire Emergency” group may receive an email with a link to join the meeting, and may select the link to navigate to collaboration interface.

By accessing the meeting, and thereby a collaboration interface (e.g., a chat interface, a video sharing platform, etc.), members of a team or group may share video, pictures, or other media, or may chat with one another to discuss or resolve the event. In a video meeting, for example, live video may be shared from webcams of the meeting attendees or live video from one or more security cameras associated with the event may be streamed, as discussed above. In some embodiments, meeting attendees can use a chat window or other interface to send messages and to view incident information. For example, a first chat message may be automatically provided when the meeting begins that includes a variety of information relating to the incident, such as the location, the affected equipment, the event type, etc.

Referring now to FIGS. 12A-12C, example interfaces for completing specific steps of an automated response procedure are shown, according to various embodiments. The various interfaces shown in FIGS. 12A-12C may be presented to a single user or team member, for example, and may indicate particular steps that the user must take to address an incident. As described above, the particular steps or actions that a user may be request to take in response to an incident may be previously established, such as when forming a group or team. More specifically, FIGS. 12A-12C may illustrate task assigned to a particular member of a team or group based on architecture 700.

Turning first to FIG. 12A, an interface 1200 is that that provides a task list 1202 for a particular user. As shown, this particular user (“User 1”) currently has two tasks in task list 1202, including “9. Contact all external emergency services—Security” and “4. Mass Access Service—Security.” These two tasks may correspond to particular steps of an automated response procedure, as described above. For example, contacting all external security services corresponds to step 9 of the automated response procedure architecture described with respect to FIG. 7. Accordingly, during setup of the automated response procedures, “User 1” was designated to handle this step of the procedure.

Selecting a particular task causes additional details about the task to be presented in a window 1204. In FIG. 12A, a user has selected “9. Contact all external emergency services—Security,” causing window 1204 to populate with information about the task the user is requested to complete. Window 1204 includes information such as a time to complete the task (e.g., “in 7 hours”), a description of the alarm, a phone number or other contact information for emergency services, etc. The user may navigate using the “form,” “history,” “diagram,” or “description” tabs to view even more information.

Before the user can complete the task, the user claims the task by selecting a “claim” button or icon. In some embodiments, if the user does not claim the task within a predetermined amount of time, the task may pass to another user to complete. Once the user has claimed and completed the task, the user may select a “complete” button to indicate that their portion of the response procedure is complete.

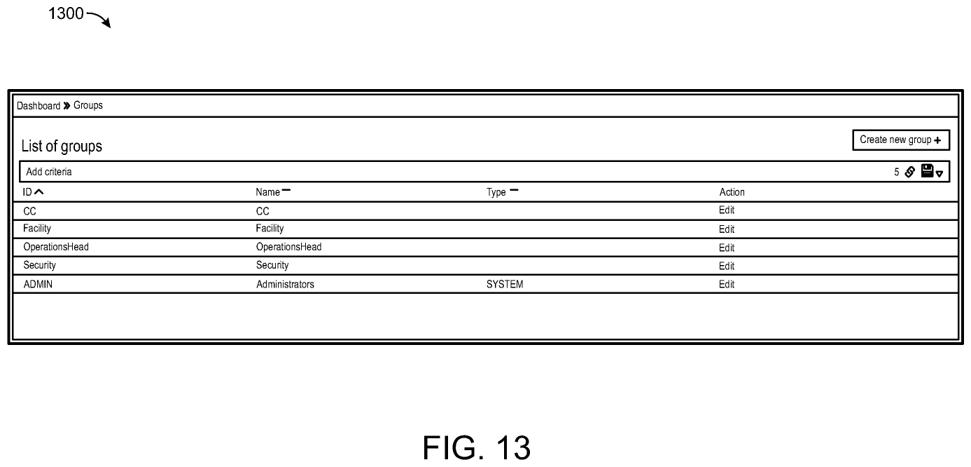

Referring now to FIG. 13, an example interface 1300 is shown for creating groups for automated response procedures, according to some embodiments. Interface 1300 is shown to include a list of currently established groups with various group ID that provide an indication of the group responsibilities. From interface 1300, a user, typically an administrator or site manager, can establish new groups or edit existing groups. For example, the user could establish a new group for responding to fire alarms, such as the “Fire Emergency” group described with respect to FIG. 11, and may select one or more other user to populate the group. In some embodiments, the user may be previously registered users, but in some cases the user establishing the group may further include contact information for the selected users of a group. Further, interface 1300 may allow the user to assign roles or particular steps of a response procedure to particular other users.

### Command and Control Interface

Referring now to FIGS. 14A-14C, an example of a command and control interface 1400 is shown, according to some embodiments. As described above with respect to FIG. 6, for example, interface 1400 may be generated based on, and in response to, a detected event and/or the generation of an incident. Specifically, interface 1400 may be generated based on the type of event associated with the created incident. In other words, interface 1400 may be a dynamic and customizable interface for viewing a wide variety of information relating to a site, equipment, and or spaces within the site, and for responding to events efficiently. Interface 1400 is generally shown to include a plurality of “tiles” (i.e., interfaces, widgets) that present various information regarding a site.

Any of the tiles described herein may represent local, intranet, or web-based, applications that may be hosted (i.e., implemented) by either system 500 or any number of other external systems (e.g., servers, remote computing devices, etc.). Accordingly, any of the tiles may present information received from a local or remote system, such as by incident response tool 504. In one example, the event data presented in an event tile is aggregated by a remote system and presented via interface 1400 (e.g., on a user device separate from the remote system). Interface1400 may advantageously provide a large amount of data relating to site operations and/or events without necessarily requiring system 500 to handle all the data. In other words, a plurality of external or internal computing systems (e.g., servers) can handle data collection, manipulation, and aggregation, and system 500 may generate a tile-based interface through which the information from other separate applications may be displayed. In this regard, utilizing tiles that display separate application data as described herein leads to a more lightweight, less processing-intensive software, as it does not require the software to ingest and normalize all of the information from disparate sources, and allows for the easy integration of third-party components (e.g., applications). That said, in various implementations, system 500 could also integrate the information from other sources, and one or more of the displayed tiles may display information ingested into and/or otherwise processed by the software generating the tile-based graphical interface.

Turning first to FIG. 14A, an overview of interface 1400 is shown, according to some embodiments. Specifically, FIG. 14A illustrates an example of a full command and control interface that may be presented across multiple user devices (e.g., multiple screens). As shown, interface 1400 provides a high-level overview of a particular site, in this example a building. For example, FIG. 14A shows that interface 1400 includes an events tile 1402 (e.g., interface 900), a model tile 1404 (e.g., showing 3D model 802), and a plurality of application interface tiles. It will be appreciated that the particular layout and selection of tiles show in FIGS. 14A-14C is for exemplary purposes only and is not intended to be limiting. One of skill in the art would appreciate that any other suitable layout and selection of interfaces or “tiles” may be implemented.

As described herein, incident response tool 504 may dynamically generate interface 1400 to present one or more applications or tiles that are applicable to an identified event or based on the role of a user. In some embodiments, at least a portion of the tiles presented in interface 1400 are selected by the user. In other words, interface 1400 may be customizable based on a user's preferences, and may be dynamically updated, either by the user or by incident response tool 504, based on a selected event. In some embodiments, interface 1400 may be updated to present a particular set of tile based on a role of the user interacting with interface 1400 or logged-in to system 500. Advantageously, changing or updating one or more tiles within interface 1400 may decrease a user's response time to an incident and increase user-friendliness by presenting the most applicable or important tiles in a single interface, based on the event type. In this regard, it will be appreciated that any of the tiles or interfaces described below with respect to interface 1400 may be changed, replaced, or moved to fit a user's preferences or a particular scenario.

As described above, the leftmost tile of FIG. 14A is events tile 1402, presenting events (e.g., alarms) for “Building 2.” In this example, events tile 1402 is a representation of interface 900, as previously described, which allows a user to search events (e.g., filter by type, location, etc.) as well as select a particular event to view additional information or to create an incident, thereby initiating response procedures. Next to the events tiles is model tile 1404 that allows a user to select either a 2D or 3D model (i.e., digital representation) of a building, floor, space, equipment, etc., associated with a selected site. In this case, a 3D model of “Building 2,” shown as 3D model 802, is presented. Advantageously, allowing a user to select between 2D and 3D viewing allows for quick identification of equipment and spaces that are near an event, while providing the user a complete view of the situation. In some embodiments, a user may select a particular event from events tile 1402, and the model presented in model tile 1404 may be automatically adjusted (e.g., zoomed-in, panned, rotated, etc.) to show a part of the model corresponding to the event (e.g., a space or device).

Interface 1400 also includes an exemplary variety of application interface tiles (e.g., widgets) that present a wide variety of information. As described above, any of the application interface tiles may be customized, either by a user or automatically in response to the selection of an event or based on the user's role. As shown, interface 1400 includes examples of a collaboration platform tile 1406, a map tile 1408, a secondary event tile 1410, and an asset health tile 1412.

Turning now to FIG. 14B, a more detailed view of the various application interface tiles is shown. Collaboration platform tile 1406 is may provide a live view of a meeting between various members of a response team, as described in detail above. In the example shown, collaboration platform tile 1406 shows a video stream from a webcam of a user (i.e., a team member), allowing multiple team members to chat while responding to an event. Collaboration platform tile 1406 may also include a chat window, audio feed, or live video feed from other cameras such as security cameras. In some embodiments, an on-ground user may be able to stream video from the scene of an event via collaboration platform tile 1406. Additionally, collaboration platform tile 1406 may be automatically rendered via interface 1400 when a meeting is started in response to an event.

Map tile 1408 provides a visual indication of the location of various events, sites, or equipment. For example, map tile 1408 may indicate the location of various buildings that are managed or monitored by a single user (e.g., a facilities manager, a security manager, etc.). In some embodiments, map tile 1408 may provide an indication of where various events are occurring. For example, a first building located in a first county may be experiencing an equipment malfunction event, while a second building in a second county may be experiencing a security breach. Accordingly, map tile 1408 allows the user to quickly locate and respond to event across multiple sites.

Secondary event tile 1410 may present a variety of information on various historical or current events. In one example, secondary event tile 1410 may display multiple events that a user is handling simultaneously. The user may select an event from secondary event tile 1410 to dynamically adjust interface 1400 and switch between events. Additionally, secondary event tile 1410 may indicate what other users (e.g., members of a team) are handling various other events.

Asset health tile 1412 may provide a variety of information regarding the health or status of various assets or equipment. For example, as shown, asset health tile 1412 may present current electricity consumption for a building or site, along with a variety of other information such as CO₂ emissions, hot water and natural gas usage, steam production, etc. Additionally, asset health tile 1412 may present real-time statuses of various connected devices (e.g., equipment 512-522). For example, asset health tile 1412 may presented a variety of devices, organized by type, and indicate how many of each device is experiencing an event (e.g., a warning or alarm), offline, or online.

Turning now to FIG. 14C, additional tiles are shown. First, a security tile 1414 is shown that includes a plurality of feeds from security cameras associated with a site or building. A user may customize which security camera feeds are shown in security tile 1414, or the feeds may change at a predetermined interval (e.g., every 30 seconds). From security tile 1414, a user may monitor live video from anywhere around a site, and may use the video feeds provided in security tile 1414 to locate and view a space associated with an event.

Also shown is a response process tile 1416. Response process tile 1416 illustrates a time and tasks associated with the response to an event. In one example, response process tile 1416 may include the tasks that are automatically initiated at the generation of an incident, as described above. In the example shown, response process tile 1416 includes a time of when various task of a response process where completed. Also included is a time stamp for when the task was completed and an indication of the user that marked the task complete. In this manner, a first user that is overseeing a response to an event may monitor the response status and how quickly the various tasks are completed. Additionally, collecting timestamps for each task may benefit in auditing and reporting of event responses.

Finally, a 2D model tile 1418 is shown. In some embodiments, 2D model tile 1418 may be presented in addition to, or in place of, model tile 1404. As shown, 2D model tile 1418 provides an aerial or overhead view (i.e., a layout) of a building or site. A user may use 2D model tile 1418 to locate an event, develop ingress or egress routes, etc. In combination with a 3D model presented in model tile 1404, the user may be presented with a complete view of a particular area of a site or building (e.g., an entire floor). In some embodiments, the 2D model shown in 2D model tile 1418 may be presented in model tile 1404, and 2D model tile 1418 may be replaced with a 3D model of the building or site.

In other embodiments, a number of other tiles may be included. A dynamic risk tile may leverage data from a dynamic risk engine, which receives, correlates, and filters threat data in real time. The threat data is continuously scored using a model to generate a map or list of potential risks, such as active shooters, bomb threats, explosion, hate crimes, virus spread, etc. The overall risk for a space or equipment is calculated based on a calculated threat rating, vulnerability rating, and cost. Accordingly a user may quickly identify potential threats or issues before they occur, and may attempt to mitigate the threat.

In other example, interface 1400 may include any of a new tile, a weather tile, a social media tile, a traffic tile, etc. Accordingly, interface 1400 may provide a feed of social media data received from a social media site, or may present current and forecasted weather data. In one example, a social media tile may be configured to track keywords associated with a site, building, stadium, etc., to identify and respond to events (e.g., a rowdy fan, a fight, overcrowding, etc.). Likewise, a weather tile could be configured to track storms so that a building could be evacuated. It should be understood that, for various applications and use cases, a wide variety of different applications and corresponding tiles could be utilized, and all such implementations are contemplated within the scope of the present disclosure.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A system for responding to events in a facility, the system comprising:
one or more memory devices having instructions stored thereon that, when executed by one or more processors, cause the one or more processors to perform operations comprising:
aggregating event data from a plurality of devices of a building management system (BMS) to generate an event list;
receiving, via a user interface, a first indication of a first event from the event list; and
in response to receiving a second indication to generate an incident based on the first event, generating the incident by:
determining an event type of the first event;
determining a set of users previously identified to respond to the event type; and
automatically generating and transmitting a meeting invite to the set of users, wherein the meeting invite includes an indication of the event type.

2. The system of claim 1, the operations further comprising generating a multi-tile user interface by:
determining a first application to be displayed within a first tile using the event type;
determining a second application to be displayed within a second tile using the event type; and
generating the multi-tile user interface including the first tile and the second tile.

3. The system of claim 2, wherein the second application to be displayed within the second tile is further determined using a role of a user.

4. The system of claim 1, the operations further comprising generating a graphical user interface including the event list and a 3-dimensional (3D) model of the facility.

5. The system of claim 4, wherein the second indication is a user input identifying the first event from the event list on the graphical user interface.

6. The system of claim 1, the operations further comprising:
identifying a predefined standard operating procedure based on the event type, the standard operating procedure including one or more corrective actions to be executed to resolve the incident; and
automatically executing the one or more corrective actions.

7. The system of claim 6, the operations further comprising presenting the standard operating procedure via a graphical user interface.

8. The system of claim 1, wherein the meeting invite includes a selectable link to at least one of a video or messaging collaboration platform.

9. The system of claim 1, the operations further comprising:
receiving, via a graphical user interface, a user input selecting the first event from the event list; and
presenting, via the graphical user interface, a 3-dimensional (3D) model of a space or equipment associated with the first event.

10. A method comprising:
aggregating event data from a plurality of devices of a building management system (BMS) to generate an event list;
receiving, via a user interface, a first indication of a first event from the event list; and
in response to receiving a second indication to generate an incident based on the first event, generating the incident by:
determining an event type of the first event;
determining a set of users previously identified to respond to the event type; and
automatically generating and transmitting a meeting invite to the set of users, wherein the meeting invite includes an indication of the event type.

11. The method of claim 10, further comprising generating a multi-tile user interface by:
determining a first application to be displayed within a first tile using the event type;
determining a second application to be displayed within a second tile using the event type; and
generating the multi-tile user interface including the first tile and the second tile.

12. The method of claim 11, wherein the second application to be displayed within the second tile is further determined using a role of a user.

13. The method of claim 10, further comprising generating a graphical user interface including the event list and a 3-dimensional (3D) model of the facility.

14. The method of claim 13, wherein the second indication is a user input identifying the first event from the event list on the graphical user interface.

15. The method of claim 10, further comprising:
identifying a predefined standard operating procedure based on the event type, the standard operating procedure including one or more corrective actions to be executed to resolve the incident; and
automatically executing the one or more corrective actions.

16. The method of claim 15, further comprising presenting the standard operating procedure via a graphical user interface.

17. The method of claim 10, wherein the meeting invite includes a selectable link to at least one of a video or messaging collaboration platform.

18. The method of claim 10, further comprising:
receiving, via a graphical user interface, a user input selecting the first event from the event list; and
presenting, via the graphical user interface, a 3-dimensional (3D) model of a space or equipment associated with the first event.

19. A method comprising:
aggregating event data from a plurality of devices of a building management system (BMS) to generate an event list;
receiving, via a user interface, a first indication of a first event from the event list; and
in response to receiving a second indication to generate an incident based on the first event, generating a multi-tile user interface by:
determining an event type of the first event;
determining a first application to be displayed within a first tile using the event type;
determining a second application to be displayed within a second tile using the event type; and
generating the multi-tile user interface including the first tile and the second tile.

20. The method of claim 19, wherein the second application to be displayed within the second tile is further determined using a role of a user.
